(19) United States
(12) Patent Application Publication
(10) Pub. No.: US 2025/0121407 A1
(43) Pub. Date: Apr. 17, 2025

(54) Method and Device for Driving a Beamforming Ultrasound Transducer Array, and Corresponding System

(71) Applicant: Stichting IMEC Nederland, Eindhoven (NL)

(72) Inventors: Marios Gourdouparis, Eindhoven (NL); Yao-Hong Liu, Eindhoven (NL); Stefano Stanzione, Veldhoven (NL)

(21) Appl. No.: 18/913,685

(22) Filed: Oct. 11, 2024

(30) Foreign Application Priority Data
Oct. 11, 2023 (EP) 23202878.7

(51) Int. Cl. B06B 1/02

(52) U.S. Cl. CPC B06B 1/0215; B06B 2201/20; B06B 2201/76

(57) ABSTRACT

The present disclosure includes methods for evaluating the bending stiffness of high aspect ratio nanosized structures. One example method for evaluating a bending stiffness of high aspect ratio nanosized structures arranged in a plurality of test patterns produced by lithography and etching in a respective plurality of different areas of a semiconductor substrate, where each test pattern includes a regular array of the high aspect ratio nanosized structures, includes scanning the regular arrays in the plurality of test patterns by an electron beam produced according to a same set of beam conditions for each array. The method also includes deriving images of the regular arrays in the respective test patterns by electron beam microscopy. Additionally, the method includes determining from each of the images an e-beam induced collapse rate representative of a percentage of structures in each array that have collapsed under an influence of the electron beam scanning.

### CROSS-REFERENCE TO RELATED APPLICATIONS

The present application is a non-provisional patent application claiming priority to European Patent Application No. EP 23202878.7, filed Oct. 11, 2023, the contents of which are hereby incorporated by reference.

### FIELD OF THE DISCLOSURE

The disclosure relates to a method for driving an ultrasound transducer array with beamforming capabilities with the aid of multiple channels, a device for driving an ultrasound transducer array with beamforming capabilities with the aid of multiple channels, and a system comprising such a device and an ultrasound transducer array being driven by the multiple channels.

### BACKGROUND

Generally, in times of an increasing number of applications employing ultrasound transducer arrays with beamforming capabilities, there is a growing need of a method for driving an ultrasound transducer array with beamforming capabilities with the aid of multiple channels, a device for driving an ultrasound transducer array with beamforming capabilities with the aid of multiple channels, and a system comprising such a device and an ultrasound transducer array being driven by the multiple channels in order to supply such applications with power in a particularly efficient manner, thereby not only ensuring minimum space requirements but also maximum flexibility.

US 2021/0306079 A1 relates a method of generating ultrasound by driving an array of ultrasonic transducers. The method comprises a charge transfer procedure. The charge transfer procedure comprises switching a terminal of a first ultrasonic transducer of the array, at a first electric potential, to a charge distribution bus, switching a terminal of a second ultrasonic transducer of the array, at a second electric potential different than the first potential, to the charge distribution bus, and allowing charge to flow between the first ultrasonic transducer and the second ultrasonic transducer through the charge distribution bus. Disadvantageously, such a configuration, especially the usage of the charge distribution bus, leads to limitations with respect to miniaturization and flexibility. In particular, the existing limitations in such a configuration, that originate from the need to have large external capacitors, are not solved with the charge distribution bus as described in US 2021/0306079 A1.

### SUMMARY

The present disclosure relates to a method for driving an ultrasound transducer array with beamforming capabilities with the aid of multiple channels, a device for driving an ultrasound transducer array with beamforming capabilities with the aid of multiple channels, and a system comprising such a device and an ultrasound transducer array being driven by the multiple channels, thereby supplying such an ultrasound transducer array with power in a particularly efficient manner especially in the sense of not only ensuring minimum space requirements, but also maximum flexibility.

The present disclosure provides for a method for driving an ultrasound transducer array with beamforming capabilities with the aid of multiple channels, the features of the second independent claim for a device for driving an ultrasound transducer array with beamforming capabilities with the aid of multiple channels, and the features of the third independent claim for a system comprising such a device and an ultrasound transducer array being driven by the multiple channels. The dependent claims contain further developments.

According to an embodiment of the disclosure, a method for driving an ultrasound transducer array with beamforming capabilities with the aid of multiple channels is provided. The method comprises the steps of generating a respective voltage wave signal with intermediate voltage steps and a certain duration of the intermediate voltage steps for each of the multiple channels by correspondingly connecting the corresponding elements in the ultrasound transducer array to a supply voltage or ground, defining corresponding relative time delays among the multiple channels to be linear, and defining phases with respect to the multiple channels such that a certain condition correlates the number of elements in the ultrasound transducer array with the number of generated phases.

In an example, an ultrasound transducer array can be supplied with power in a particularly efficient manner especially in the sense of not only ensuring minimum space requirements but also maximum flexibility.

Further in another example, the need for external capacitors in ultrasound transducer array or ultrasound adiabatic driver architectures, respectively, can efficiently be eliminated. In particular, such capacitors are eliminated by ensuring that for all elements of a transducer array with multilevel driving, at all intermediate voltage steps their charge is recycled with other elements of the transducer array.

In other words, efficiently ensuring that every transducer element recycles its charge with another transducer element during all intermediate voltage steps of its charging and discharging phases results in no need for external capacitors exemplarily for an adiabatic pulser.

With respect to the above-mentioned supply voltage, in some embodiments the supply voltage may comprise or is an intermediate voltage or an intermediate voltage node, such as a plurality of intermediate voltages or a plurality of intermediate voltage nodes.

According to an embodiment of the disclosure, especially in the context of the certain condition, the number of elements in the ultrasound transducer array is equal to an integer multiple of the number of generated phases.

In an example, for instance, it can efficiently be made sure that whenever a channel is rising, there is another channel dropping at the same time.

According to an embodiment of the disclosure, the method further comprises the step of defining a relation regarding a minimum time delay between the multiple channels and the certain duration of the intermediate voltage steps such that the minimum time delay between the multiple channels is equal to two times the certain duration of the intermediate voltage steps.

In an example, it can efficiently be ensured that two channels with a minimum relative delay share their charge with the same channel at consecutive voltage levels.

According to an embodiment of the disclosure, the method further comprises the step of defining a relation regarding a certain time interval within each corresponding period of the respective ultrasound transducer that each pulse is connected to the supply voltage or the ground, the certain duration of the intermediate voltage steps, and a minimum time delay between the multiple channels, especially the minimum time delay between the multiple channels according to the implementation form above, such that the sum of the certain time interval and the certain duration of the intermediate voltage steps is equal to an integer multiple of the minimum time delay between the multiple channels, especially the minimum time delay between the multiple channels according to the implementation form above.

In an example, for instance, it can efficiently be ensured that any channel can share its charge with other channels for all intermediate voltage steps.

According to an embodiment of the disclosure, the method further comprises the step of defining a relation regarding the number N of the intermediate voltage steps, the certain duration Δ of the intermediate voltage steps, a certain time interval t1 within each corresponding period T of the respective ultrasound transducer that each pulse is connected to the supply voltage or the ground, especially the certain time interval according to the implementation form above, and the corresponding period T of the respective ultrasound transducer such that the following equation applies:

$$2 ( N - 2 ) Δ + 2 t 1 = T .$$

In an example, it can efficiently be ensured that the corresponding multilevel driving pulse has the same period as the respective ultrasound transducer.

According to an embodiment of the disclosure, the method further comprises the step of defining a time delay between the multiple channels to be an odd integer multiple or an even integer multiple of a minimum time delay between the multiple channels, especially the minimum time delay between the multiple channels according to any of the corresponding implementation forms above.

In an example, for instance, full charge recycling can be achieved not only for a minimum steering angle.

According to an embodiment of the disclosure, the method further comprises the step of in the case that the time delay between the multiple channels is equal to an even integer multiple of the minimum time delay between the multiple channels, modifying the linearity of the corresponding relative time delays among the multiple channels such that at least a part of the corresponding time delay steps between the multiple channels is replaced by respective time delay steps with an odd integer multiple of the minimum time delay between the multiple channels, the odd integer multiple being one less than the even integer multiple.

In an example, full charge recycling can be achieved for all steering angles in a particularly efficient manner.

According to an embodiment of the disclosure, a device for driving an ultrasound transducer array with beamforming capabilities with the aid of multiple channels is provided. The device comprises multiple switches, each of which especially comprising a capacitance or a parasitic capacitance, for driving the multiple channels, and a control unit being in communication with the multiple switches. In this context, the control unit is configured to control the multiple switches such that a respective voltage wave signal with intermediate voltage steps and a certain duration of the intermediate voltage steps for each of the multiple channels is generated by correspondingly connecting the corresponding elements in the ultrasound transducer array to a supply voltage or ground. In addition to this, the control unit is configured to define corresponding relative time delays among the multiple channels to be linear. Further additionally, the control unit is configured to define phases with respect to the multiple channels such that a certain condition correlates the number of elements in the ultrasound transducer array with the number of generated phases.

In an example, an ultrasound transducer array can be supplied with power in a particularly efficient manner especially in the sense of not only ensuring minimum space requirements but also maximum flexibility.

In another example, the need for external capacitors in ultrasound transducer array or ultrasound adiabatic driver architectures, respectively, can efficiently be eliminated. In particular, such capacitors are eliminated by ensuring that for all elements of a transducer array with multilevel driving, at all intermediate voltage steps their charge is recycled with other elements of the transducer array.

In other words, efficiently ensuring that every transducer element recycles its charge with another transducer element during all intermediate voltage steps of its charging and discharging phases results in no need for external capacitors exemplarily for an adiabatic pulser.

With respect to the above-mentioned supply voltage, it is noted that it might be particularly advantageous if the supply voltage comprises or is an intermediate voltage or an intermediate voltage node, such as a plurality of intermediate voltages or a plurality of intermediate voltage nodes.

According to an embodiment of the disclosure, in the context of the certain condition, the number of elements in the ultrasound transducer array is equal to an integer multiple of the number of generated phases. In addition to this or as an alternative, the control unit is configured to share the corresponding charge of the multiple switches, especially of the capacitance or the parasitic capacitance of each of the multiple switches, between the multiple switches with the aid of an intermediate supply voltage.

In an example, for instance, it can efficiently be made sure that whenever a channel is rising, there is another channel dropping at the same time.

According to a further implementation form of the embodiment of the disclosure, the control unit is further configured to define a relation regarding a minimum time delay between the multiple channels and the certain duration of the intermediate voltage steps such that the minimum time delay between the multiple channels is equal to two times the certain duration of the intermediate voltage steps.

In an example, it can efficiently be ensured that two channels with a minimum relative delay share their charge with the same channel at consecutive voltage levels.

According to a further implementation form of the embodiment of the disclosure, the control unit is further configured to define a relation regarding a certain time interval within each corresponding period of the respective ultrasound transducer that each pulse is connected to the supply voltage or the ground, the certain duration of the intermediate voltage steps, and a minimum time delay between the multiple channels, especially the minimum time delay between the multiple channels according to the implementation form above, such that the sum of the certain time interval and the certain duration of the intermediate voltage steps is equal to an integer multiple of the minimum time delay between the multiple channels, especially the minimum time delay between the multiple channels according to the implementation form above.

In an example, for instance, it can efficiently be ensured that any channel can share its charge with other channels for all intermediate voltage steps.

According to a further implementation form of the embodiment of the disclosure, the control unit is further configured to define a relation regarding the number N of the intermediate voltage steps, the certain duration Δ of the intermediate voltage steps, a certain time interval t1 within each corresponding period T of the respective ultrasound transducer that each pulse is connected to the supply voltage or the ground, especially the certain time interval according to the implementation form above, and the corresponding period T of the respective ultrasound transducer such that the following equation applies:

$$2 ( N - 2 ) Δ + 2 t 1 = T .$$

In an example, it can efficiently be ensured that the corresponding multilevel driving pulse has the same period as the respective ultrasound transducer.

According to a further implementation form of the embodiment of the disclosure, the control unit is further configured to define a time delay between the multiple channels to be an odd integer multiple or an even integer multiple of a minimum time delay between the multiple channels, especially the minimum time delay between the multiple channels according to any of the corresponding implementation forms above.

In an example, for instance, full charge recycling can be achieved not only for a minimum steering angle.

According to a further implementation form of the embodiment of the disclosure, the control unit is further configured to in the case that the time delay between the multiple channels is equal to an even integer multiple of the minimum time delay between the multiple channels, modify the linearity of the corresponding relative time delays among the multiple channels such that at least a part of the corresponding time delay steps between the multiple channels is replaced by respective time delay steps with an odd integer multiple of the minimum time delay between the multiple channels, the odd integer multiple being one less than the even integer multiple.

In an example, full charge recycling can be achieved for all steering angles in a particularly efficient manner.

According to another embodiment of the disclosure a system is provided. The system comprises a device for driving an ultrasound transducer array with beamforming capabilities with the aid of multiple channels according to the embodiment of the disclosure or any of its implementation forms, respectively, and an ultrasound transducer array being driven by the multiple channels. In this context, the system may be used in the context of at least one of wireless power transfer, especially wireless power transfer to medical implants, ultrasound imaging, especially ultrasound imaging in a medical context, ultrasound stimulation, especially ultrasound stimulation in a medical context and/or neuromodulation, or any combination thereof.

In an example, the ultrasound transducer array is supplied with power in a particularly efficient manner especially in the sense of not only ensuring minimum space requirements but also maximum flexibility.

In another example, the need for external capacitors in ultrasound transducer array or ultrasound adiabatic driver architectures, respectively, can efficiently be eliminated. In particular, such capacitors are eliminated by ensuring that for all elements of a transducer array with multilevel driving, at all intermediate voltage steps their charge is recycled with other elements of the transducer array.

In other words, efficiently ensuring that every transducer element recycles its charge with another transducer element during all intermediate voltage steps of its charging and discharging phases results in no need for external capacitors exemplarily for an adiabatic pulser.

### BRIEF DESCRIPTION OF THE DRAWINGS

Exemplary embodiments of the disclosure are now further explained with respect to the drawings by way of example only, and not for limitation. In the drawings:

FIG. 1 shows a flow chart of an example embodiment of the disclosure;

FIG. 2 illustrates charge recycling timing in the sense of the disclosure in a general manner;

FIG. 3 shows an example of charge recycling timing with respect to four channels;

FIG. 4 illustrates an example of the correlation between the number of elements in the ultrasound transducer array and the number of generated phases with respect to four channels;

FIG. 5 illustrates exemplary relative delays between elements of the ultrasound transducer array which recycle charge at consecutive levels with respect to two channels;

FIG. 6 illustrates exemplary relative delays between charging and discharging with respect to two channels;

FIG. 7 shows an example of full charge sharing for all angles of the disclosure;

FIG. 8 shows a further example of full charge sharing for all angles;

FIG. 9 shows a further example of full charge sharing for all angles;

FIG. 10 shows a further example of full charge sharing for all angles;

FIG. 11 shows a further example of full charge sharing for all angles;

FIG. 12 shows an exemplary embodiment of an inventive device for driving an ultrasound transducer array with beamforming capabilities with the aid of multiple channels;

FIG. 13 shows exemplary circuitry in the sense of the disclosure and corresponding functioning thereof; and

FIG. 14 shows further exemplary circuitry of the disclosure and corresponding functioning thereof.

### DETAILED DESCRIPTION

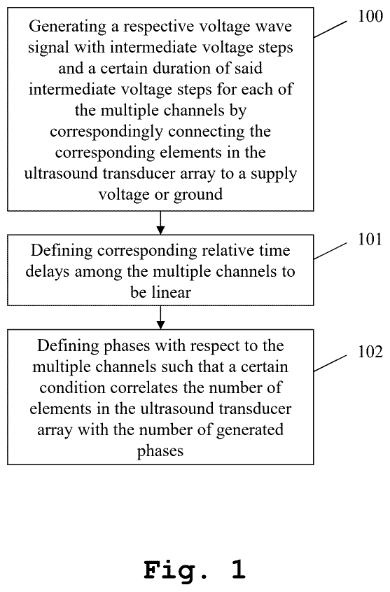

Firstly, FIG. 1 shows a flow chart of an embodiment of the method for driving an ultrasound transducer array with beamforming capabilities with the aid of multiple channels.

In accordance with the FIG. 1, a first step 100 comprises generating a respective voltage wave signal with intermediate voltage steps and a certain duration of the intermediate voltage steps for each of the multiple channels by correspondingly connecting the corresponding elements in the ultrasound transducer array to a supply voltage or ground.

With respect to the above-mentioned certain duration of the intermediate voltage steps, it is noted that the certain duration may especially be denoted as Δ in the following.

Furthermore, with respect to the above-mentioned supply voltage, it is noted that the supply voltage may especially be denoted as VDDHV, whereas the above-mentioned ground may especially be denoted as VSS in the following.

Moreover, with respect to the above-mentioned multiple channels, it is noted that the multiple channels may correspondingly be equipped with one of the reference signs 11, 12, 13, 14 within the scope of the drawings.

In addition to this, as it can further be seen from FIG. 1, a second step 101 comprises defining corresponding relative time delays among the multiple channels to be linear.

Further additionally, a third step 102 comprises defining phases with respect to the multiple channels such that a certain condition correlates the number of elements in the ultrasound transducer array with the number of generated phases.

It is noted that full charge recycling may be achieved for all channels at all steering angles, and thus the usage of external capacitors can be omitted. It is further noted that full charge recycling is especially achieved when every transducer element at all steps during its multilevel charging and discharging recycles all its capacitor charge with another transducer element.

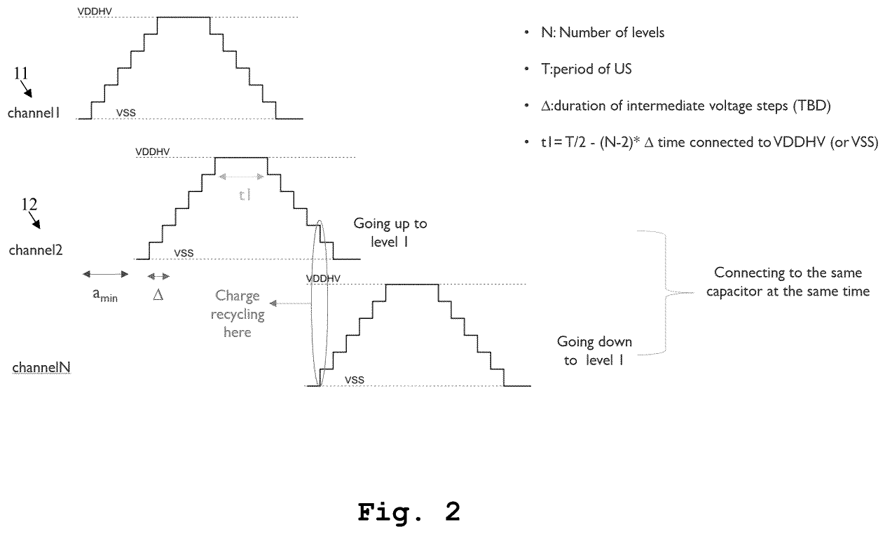

A charge recycling timing is illustrated by FIG. 2 especially in order to elucidate how charge recycling can efficiently be maximized.

It is noted that N may especially denote the number of levels or the number of the intermediate voltage steps, respectively, in the following.

It is further noted that T or Tus, respectively, may especially denote the corresponding period of the respective ultrasound transducer in the following.

As it can also be seen from FIG. 2, in the following, t1 may especially denote a certain time interval within each corresponding period T of the respective ultrasound transducer that each pulse is connected to the supply voltage VDDHV or the ground VSS.

In addition to this, it is noted that in the following, aₘᵢₙ may especially denote a minimum time delay between the multiple channels.

In accordance with FIG. 2, especially for charge recycling, one of the multiple channels may go up to a certain level or a certain intermediate voltage step, respectively, whereas another one of the multiple channels may go down to the same certain level or the same certain intermediate voltage step, respectively. In this context, it is noted that it may especially be connected to the same capacitance or capacitor, respectively, at the same time.

Accordingly, especially in the context of the first step 100 of FIG. 1, it might be particularly advantageous if the respective voltage wave signal is generated such that one of the multiple channels goes up to a certain intermediate voltage step, whereas another one of the multiple channels goes down to the same certain intermediate voltage step.

In addition to this, it is noted that it might be particularly advantageous if, especially in the context of step 100 of FIG. 1, the method further comprises the step of connecting to the same capacitance or capacitor at the same time.

With respect to the above-mentioned capacitance or capacitor, respectively, it is noted that the capacitance or capacitor, respectively, can be understood as a parasitic capacitance or a parasitic capacitor, respectively, such as part of the corresponding ultrasound transducer.

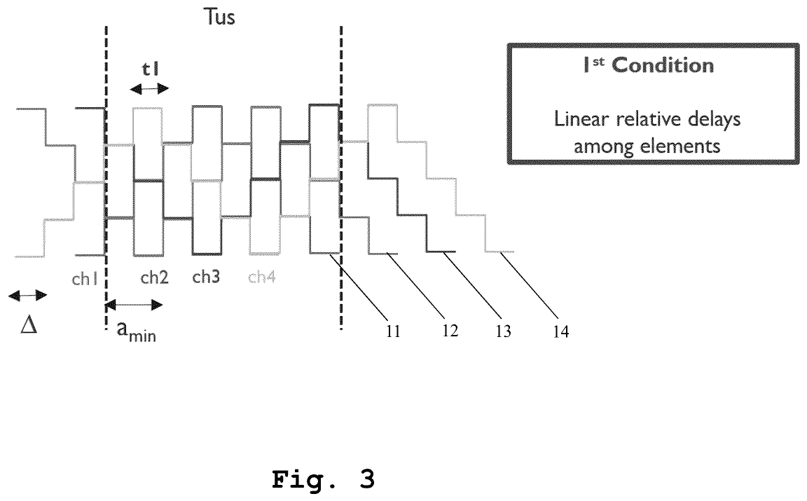

Now, with respect to FIG. 3, an example of charge recycling timing with respect to the four channels 11, 12, 13, 14 is shown. For the sake of completeness, it is noted that each of the formula symbols used in FIG. 3 has already been explained above.

In accordance with the FIG. 3 or step 101 of FIG. 1, respectively, for full charge recycling with respect to the ultrasound transducer array such as for a minimum steering angle, linear relative delays may especially be defined among the corresponding elements of the ultrasound transducer array.

Especially in the light of FIG. 3, it is noted that the disclosure or the method, respectively, may be used in the context for ultrasound transmitting systems driving millimeter sized transducer arrays especially for sub-centimeter range wireless powering applications.

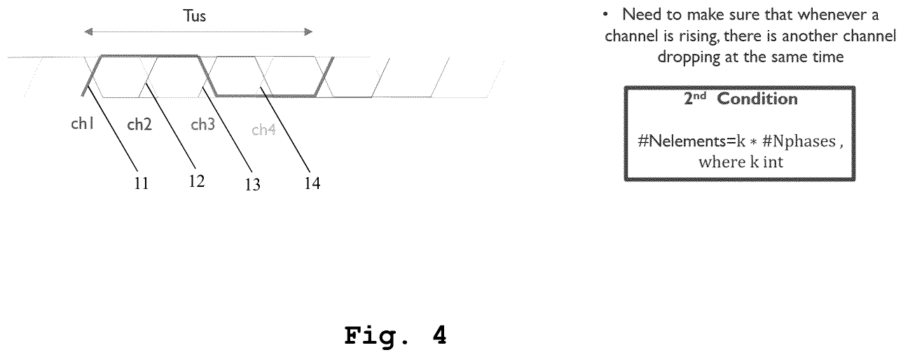

Furthermore, according to FIG. 4, a correlation between the number of elements in or of the ultrasound transducer array and the number of generated phases with respect to the exemplary four channels 11, 12, 13, 14 is illustrated.

In accordance with the FIG. 4, especially in the context of the above-mentioned certain condition correlating the number of elements in the ultrasound transducer array with the number of generated phases according to step 102 of FIG. 1, the number of elements in the ultrasound transducer array may be equal to an integer multiple k of the number of generated phases.

It is noted that in some examples related to step 100 of FIG. 1, the method further comprises the step of generating the respective voltage wave signal such that whenever one of the multiple channels is rising, another one of the multiple channels is dropping at the same time.

It is noted that in some examples with a given transducer resonant frequency, the method further comprises the step of linking the number of generated phases to the corresponding delay resolution, such as the above-mentioned minimum time delay.

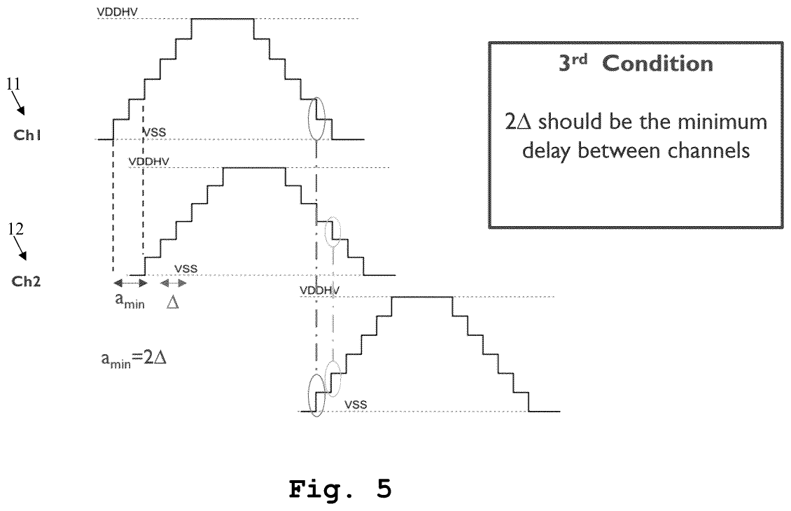

Now, with respect to FIG. 5, relative delays between elements in or of the ultrasound transducer array which recycle charge at consecutive levels exemplarily with respect to two channels 11, 12 are illustrated.

In accordance with the FIG. 5, the above-mentioned minimum time delay may be equal to two times the above-mentioned certain duration.

It is noted that in some examples the method further comprises the step of defining a relation regarding the minimum time delay aₘᵢₙ between the multiple channels and the certain duration Δ of the intermediate voltage steps such that the minimum time delay aₘᵢₙ between the multiple channels is equal to two times the certain duration Δ of the intermediate voltage steps.

It is noted that in some examples in the context of step 100 of FIG. 1, the method further comprises the step of generating the respective voltage wave signal such that two of the multiple channels with a minimum relative delay share their charge with the same one of the multiple channels at consecutive voltage levels or consecutive intermediate voltage steps, respectively.

Furthermore, the method may comprise the step of determining the certain duration of the intermediate voltage steps with respect to the minimum time delay.

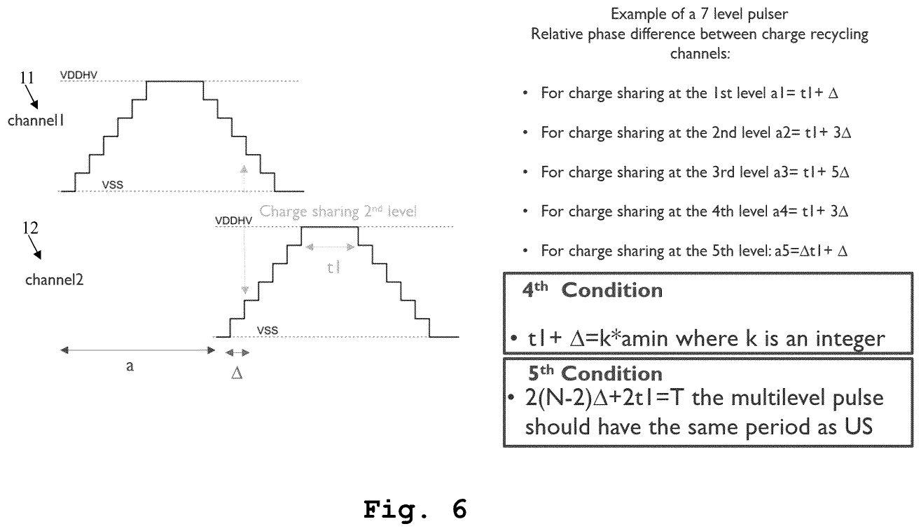

As it can be seen from FIG. 6, relative delays between charging and discharging elements of the ultrasound transducer array may be determined such that any channel can share or shares its charge with other channels for all intermediate voltage steps.

In addition to this, as it can also be seen from FIG. 6, that the corresponding multilevel driving pulse has the same period as the respective ultrasound transducer.

Especially in the light of the FIG. 6, the method further comprises the step of defining a relation regarding the certain time interval t1 within each corresponding period T of the respective ultrasound transducer that each pulse is connected to the supply voltage VDDHV or the ground VSS, the certain duration Δ of the intermediate voltage steps, and the minimum time delay aₘᵢₙ between the multiple channels such that the sum of the certain time interval t1 and the certain duration Δ of the intermediate voltage steps is equal to an integer multiple k of the minimum time delay aₘᵢₙ between the multiple channels.

Additionally, also especially in the light of FIG. 6, the method further comprises the step of defining a relation regarding the number N of the intermediate voltage steps, the certain duration Δ of the intermediate voltage steps, the certain time interval t1 within each corresponding period T of the respective ultrasound transducer that each pulse is connected to the supply voltage VDDHV or the ground VSS and the corresponding period T of the respective ultrasound transducer such that the following equation applies:

$$2 ( N - 2 ) Δ + 2 t 1 = T .$$

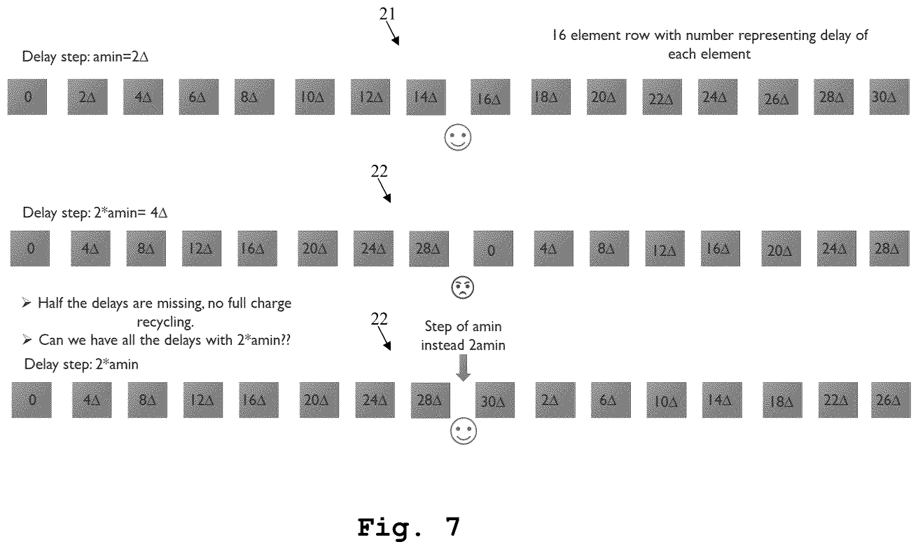

Now, with respect to FIG. 7 to FIG. 11, examples of full charge sharing for all angles or all steering angles, respectively, are illustrated, whereas FIG. 2 to FIG. FIG. 6 discussed above may especially be understood in the context of full charge recycling with respect to the ultrasound transducer array such as for a minimum steering angle as already indicated above.

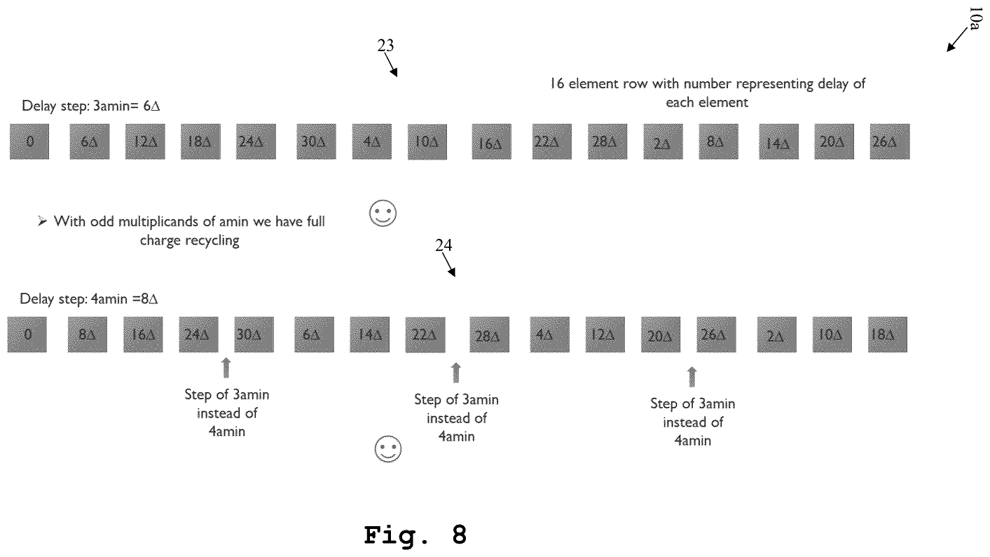

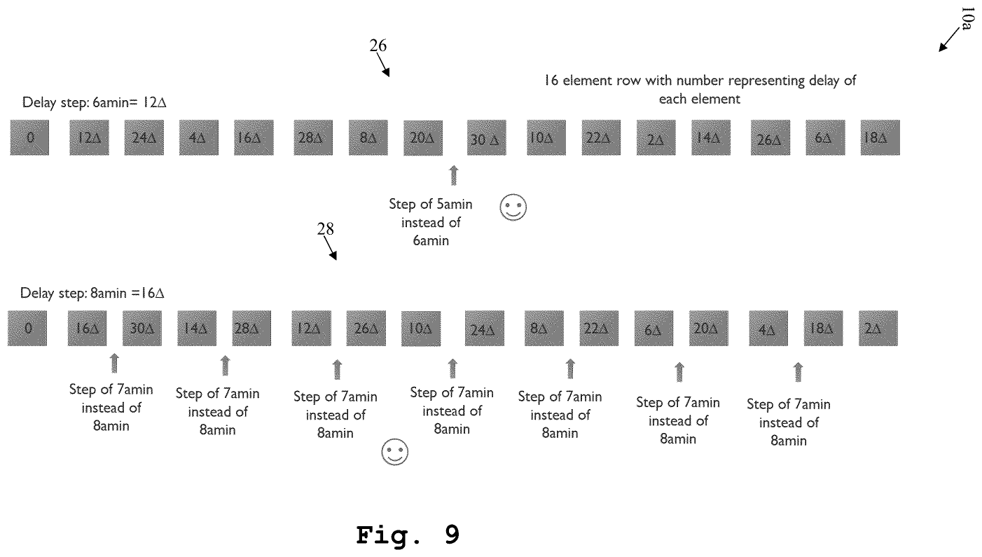

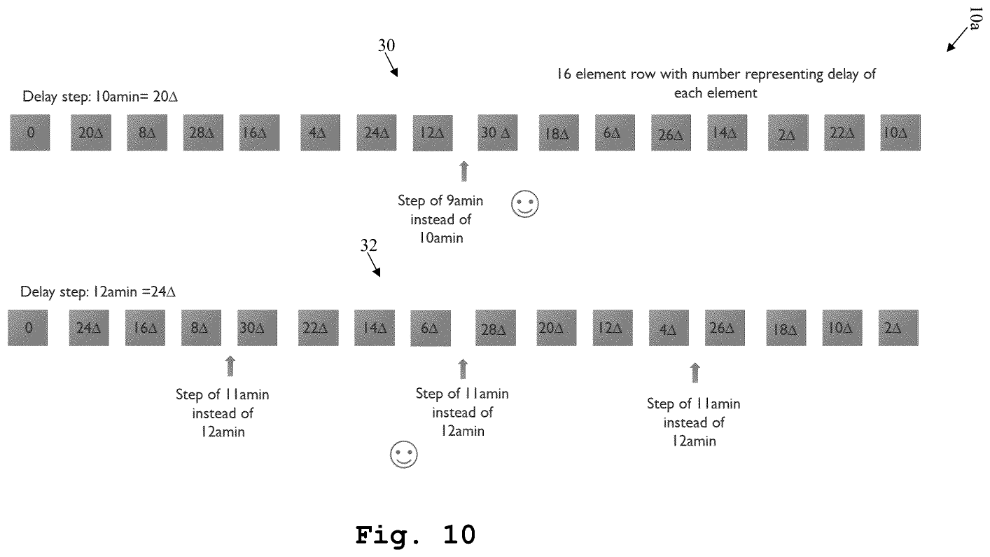

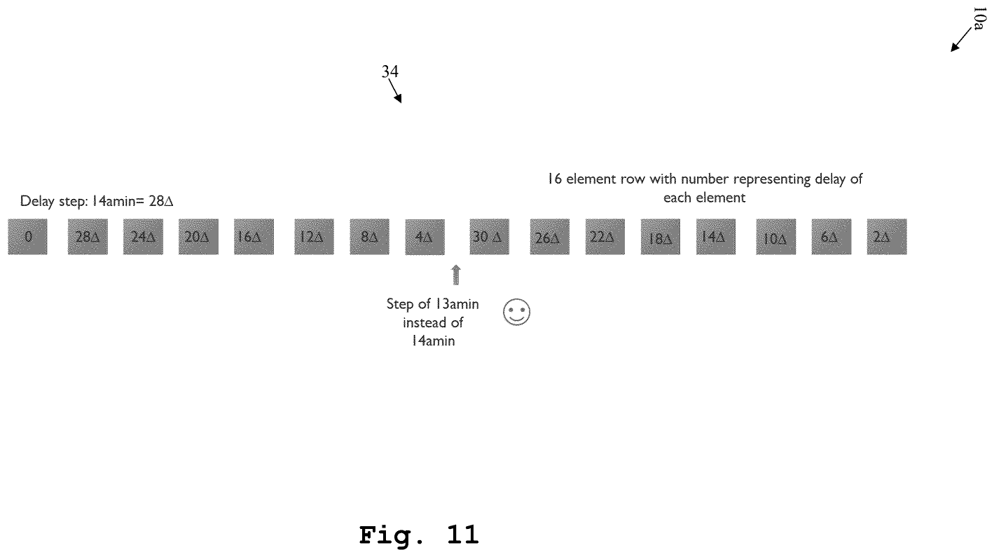

Especially in the light of the FIG. 7 to FIG. 11, the method further comprises the step of defining a time delay between the multiple channels to be an odd integer multiple, as illustrated by reference sign 21 of FIG. 7 and reference sign 23 of FIG. 8, or an even integer multiple, as illustrated by reference sign 22 of FIG. 7, reference sign 24 of FIG. 8, reference signs 26 and 28 of FIG. 9, reference signs 30 and 32 of FIG. 10, and reference sign 34 of FIG. 11, of the minimum time delay aₘᵢₙ between the multiple channels 11, 12, 13, 14.

As it can be seen from FIG. 7 and FIG. 8, especially reference signs 21 and 23, in the case that the time delay between the multiple channels, such as the above-mentioned channels 11, 12, 13, 14, is equal to an odd integer multiple of the minimum time delay aₘᵢₙ between the multiple channels, full charge recycling is achieved for all angles or all steering angles, respectively.

Furthermore, in accordance with FIG. 7 to FIG. 11, especially reference signs 22, 24, 26, 28, 30, 32, 34, the method further comprises the step of in the case that the time delay between the multiple channels is equal to an even integer multiple of the minimum time delay aₘᵢₙ between the multiple channels, modifying the linearity of the corresponding relative time delays among the multiple channels such that at least a part of the corresponding time delay steps between the multiple channels is replaced by respective time delay steps with an odd integer multiple of the minimum time delay aₘᵢₙ between the multiple channels, the odd integer multiple being one less than the even integer multiple.

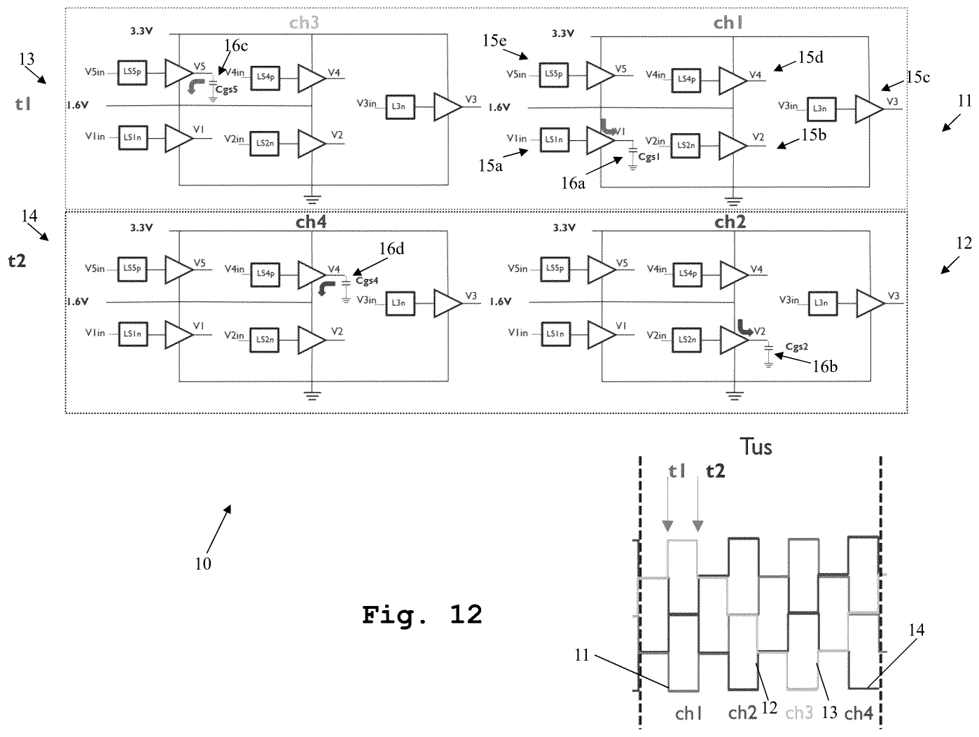

Now, with respect to FIG. 12, an exemplary embodiment of a device 10 for driving an ultrasound transducer array with beamforming capabilities with the aid of multiple channels 11, 12, 13, 14 is depicted.

In accordance with the FIG. 12, the device 10 comprises multiple switches, each of which especially comprising a capacitance or a parasitic capacitance, for driving the multiple channels 11, 12, 13, 14.

For the sake of completeness, with respect to the multiple switches and the capacitances or parasitic capacitances, respectively, it is noted that in this exemplary case according to FIG. 12, a few representatives of the multiple switches are equipped with reference signs 15a, 15b, 15c, 15d, 15e, whereas by analogy therewith, a few representatives of the capacitances or parasitic capacitances, respectively, are equipped with reference signs 16a, 16b, 16c, 16d.

In addition to this, the device comprises a control unit being in communication with the multiple switches. For the sake of completeness, it is noted that FIG. 12 does not explicitly show the control unit.

With respect to the control unit, it is noted that the control unit is configured to control the multiple switches such that a respective voltage wave signal with intermediate voltage steps and a certain duration, such as the above-mentioned certain duration Δ, of the intermediate voltage steps for each of the multiple channels 11, 12, 13, 14 is generated by correspondingly connecting the corresponding elements in the ultrasound transducer array to a supply voltage, such as the above-mentioned supply voltage VDDHV, exemplarily being 3.3 V, or ground, such as the above-mentioned ground VSS.

Additionally, the control unit is configured to define corresponding relative time delays among the multiple channels 11, 12, 13, 14 to be linear.

Further additionally, the control unit is configured to define phases with respect to the multiple channels 11, 12, 13, 14 such that a certain condition correlates the number of elements in the ultrasound transducer array with the number of generated phases.

Especially in the light of FIG. 12, the device 10 may be based on a switch driver architecture that especially allows for charge recycling also in the switch drivers.

As it can exemplarily be seen from FIG. 12, a five-level adiabatic pulser is used especially with a corresponding switch driving circuit for each of the multiple channels 11, 12, 13, 14. Accordingly, in some examples the device, such as the device 10, comprises a pulser, such as: a five-level pulser, an adiabatic pulser, a five-level adiabatic pulser, operating with a corresponding switch driving circuit for each of the multiple channels such as the channels 11, 12, 13, 14.

Furthermore, the device, such as the device 10, may comprise at least one level shifter and/or at least one buffer for providing each of the corresponding driving voltages, exemplarily the five driving voltages, that drive the multiple switches, such as the switches 15a, 15b, 15c, 15d, 15e, of the device 10 or the pulser, respectively.

With respect to the at least one buffer, it is noted that each buffer may charge and discharge the capacitance or parasitic capacitance, respectively, such as the ones being representatively equipped with reference signs 16a, 16b, 16c, 16d, of the corresponding switch. It is noted that this can lead to a power consumption which will be called gate charge loss in the following.

Especially in the light of the gate charge loss, the device, such as the device 10, or the pulser, respectively, is configured to use an intermediate supply voltage, such as the half of or substantially the half of the supply voltage, exemplarily being 1.6 V, especially to reduce an overdrive voltage of the switches, such as the switches 15a, 15b, 15c, 15d, 15e, and thus also reduce the gate charge loss at the at least one buffer or the driving buffers, respectively.

With respect to the above-mentioned term “substantially the half”, it is noted that the term can especially be understood as a deviation of not more than 3-20 percent from the half.

For further illumination, corresponding functioning of the device 10 should shortly be outlined in the following. As depicted in FIG. 12, especially thanks to full charge recycling, whenever there is a channel, exemplarily channel 13, in which the parasitic capacitance, exemplarily the parasitic capacitance 16c, of the corresponding switch, exemplarily of the fifth switch, is discharged to the 1.6 V node, there is another channel, exemplarily channel 11, in which the parasitic capacitance, exemplarily the parasitic capacitance 16a, of the corresponding switch, exemplarily of the first switch, is charged to the 1.6 V node. This allows charge sharing of the parasitic capacitance charge between the two channels.

Similarly, whenever there is a channel, exemplarily channel 14, in which the parasitic capacitance, exemplarily the parasitic capacitance 16d, of the corresponding switch, exemplarily of the fourth switch, is discharged to the 1.6 V node, there is another channel, exemplarily channel 12, in which the parasitic capacitance, exemplarily the parasitic capacitance 16b, of the corresponding switch, exemplarily of the second switch, is charged to the 1.6 V node.

In some examples, charge recycling of the switch parasitic capacitance charge results in no or at least less power drawn from the corresponding intermediate voltage supply of 1.6 V and to overall transducer driving efficiency improvement.

Moreover, if each of the multiple switches, such as the switches 15a, 15b, 15c, 15d, 15e, comprises a switch driver. Accordingly, there may especially be multiple switch drivers.

In this context, supplying a first subset of the multiple switch drivers, the first subset is connected to the above-mentioned intermediate supply voltage and the above-mentioned ground, and/or for supplying a second subset of the multiple switch drivers, the second subset is connected to the above-mentioned intermediate supply voltage and the above-mentioned supply voltage, and/or for supplying a third subset of the multiple switch drivers, the third subset is connected to the above-mentioned supply voltage and the above-mentioned ground.

Especially in the case of the above-mentioned five-level pulser or the above-mentioned five-level adiabatic pulser, respectively it might be particularly if especially for each of the multiple channels, the device or the pulser, respectively, comprises five switches, each of which may comprises a switch driver. Accordingly, the device or the pulser, respectively, comprises five switch drivers especially for each of the multiple channels.

In this context, supplying a first one and a second one of the five switch drivers, each of the first and second switch driver is connected to the above-mentioned intermediate supply voltage and the above-mentioned ground, and/or for supplying a third one of the five switch drivers, the third switch driver is connected to the above-mentioned supply voltage and the above-mentioned ground, and/or for supplying a fourth one and a fifth one of the five switch drivers, each of the fourth and fifth switch driver is connected to the above-mentioned intermediate supply voltage and the above-mentioned supply voltage.

Furthermore, the number of elements in or of the ultrasound transducer array may be equal to an integer multiple k of the number of generated phases.

Additionally or alternatively, the control unit may be configured to share the corresponding charge of the multiple switches, such as the switches 15a, 15b, 15c, 15d, 15e, especially of the capacitance or the parasitic capacitance, such as the parasitic capacitances 16a, 16b, 16c, 16d, of each of the multiple switches, between the multiple switches with the aid of an intermediate supply voltage, such as the above-mentioned intermediate supply voltage.

Moreover, the control unit is further configured to define a relation regarding a minimum time delay, such as the above-mentioned minimum time delay aₘᵢₙ, between the multiple channels 11, 12, 13, 14 and the certain duration, such as the above-mentioned certain duration Δ, of the intermediate voltage steps such that the minimum time delay between the multiple channels 11, 12, 13, 14 is equal to two times the certain duration of the intermediate voltage steps.

It is further noted that the control unit may further be configured to define a relation regarding a certain time interval, such as the above-mentioned certain time interval t1, within each corresponding period, such as the above-mentioned corresponding period T, of the respective ultrasound transducer that each pulse is connected to the supply voltage, such as the above-mentioned supply voltage VDDHV, or the ground, such as the above-mentioned ground VSS, the certain duration of the intermediate voltage steps, and a minimum time delay between the multiple channels 11, 12, 13, 14, especially the above-mentioned minimum time delay aₘᵢₙ between the multiple channels 11, 12, 13, 14, such that the sum of the certain time interval and the certain duration of the intermediate voltage steps is equal to an integer multiple, such as the above-mentioned integer multiple k, of the minimum time delay between the multiple channels 11, 12, 13, 14, especially the minimum time delay aₘᵢₙ between the multiple channels 11, 12, 13, 14.

Furthermore, the control unit is further configured to define a relation regarding the number N of the intermediate voltage steps, the certain duration Δ of the intermediate voltage steps, a certain time interval, especially the certain time interval t1, within each corresponding period T of the respective ultrasound transducer that each pulse is connected to the supply voltage or the ground, and the corresponding period T of the respective ultrasound transducer such that the following equation applies:

$$2 ( N - 2 ) Δ + 2 t 1 = T .$$

It is further noted the control unit is further configured to define a time delay between the multiple channels 11, 12, 13, 14 to be an odd integer multiple, such as exemplarily illustrated by the above-mentioned reference signs 21, 23, or an even integer multiple, such as exemplarily illustrated by the above-mentioned reference signs 22, 24, 26, 28, 30, 32, 34, of a minimum time delay between the multiple channels 11, 12, 13, 14, especially the above-mentioned minimum time delay aₘᵢₙ between the multiple channels 11, 12, 13, 14.

In this context, the control unit may further be configured to in the case that the time delay between the multiple channels 11, 12, 13, 14 is equal to an even integer multiple, such as exemplarily illustrated by the above-mentioned reference signs 22, 24, 26, 28, 30, 32, 34, of the minimum time delay between the multiple channels 11, 12, 13, 14, modify the linearity of the corresponding relative time delays among the multiple channels 11, 12, 13, 14 such that at least a part of the corresponding time delay steps between the multiple channels 11, 12, 13, 14 is replaced by respective time delay steps with an odd integer multiple of the minimum time delay between the multiple channels 11, 12, 13, 14, the odd integer multiple being one less than the even integer multiple.

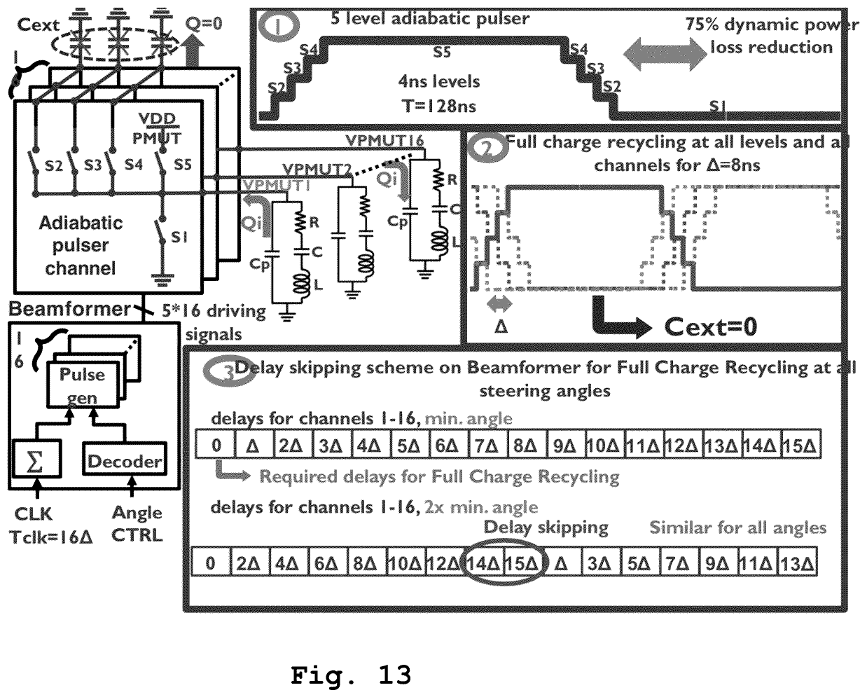

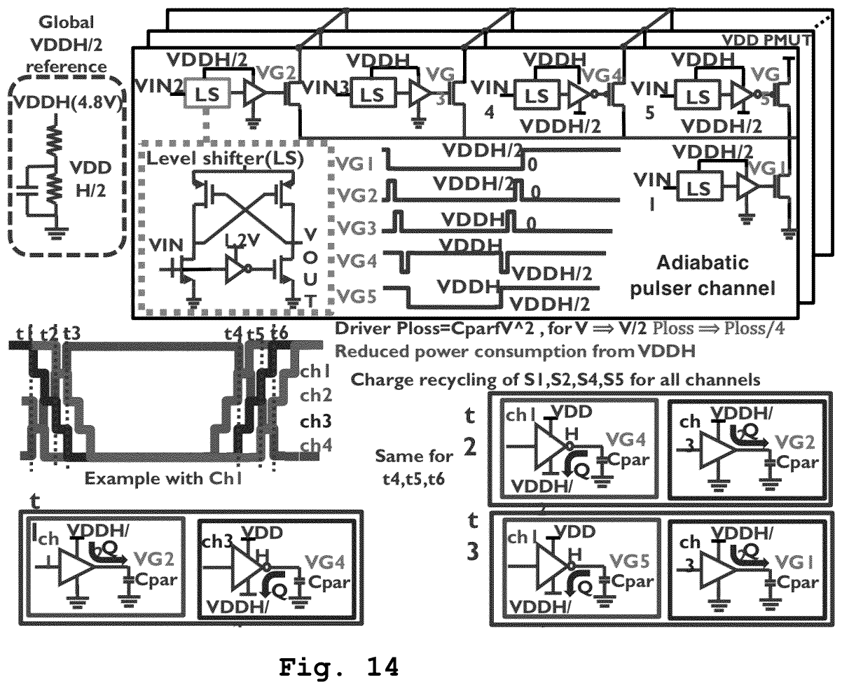

Finally, with respect to FIG. 13 and FIG. 14, exemplary circuitry in the sense of driving an ultrasound transducer array with beamforming capabilities with the aid of multiple channels and corresponding functioning thereof is illustrated. For instance, the device 10 of FIG. 12 may comprise at least a part of the circuitry.

For the sake of brevity, since a major part of the explanations above especially regarding FIG. 7 to FIG. 12 analogously applies for FIG. 13 and FIG. 14, some aspects of the FIG. 13 and FIG. 14 are emphasized in the following instead of extensively explaining each of FIG. 13 and FIG. 14.

In accordance with FIG. 13, a five-level adiabatic pulser with 16 channels is used. In this context, the corresponding period T of the respective ultrasound transducer is exemplarily equal to 128 nanoseconds. A corresponding adiabatic pulser channel comprises five switches, exemplarily the switches S1, S2, S3, S4, S5.

Furthermore, in this exemplary case according to FIG. 13, full charge recycling can be achieved at all levels and all channels for the certain duration Δ of the intermediate voltage steps being equal to 8 nanoseconds. For instance, no external capacitors are needed, thereby significantly saving space.

Moreover, a beamformer or a beamforming unit, respectively, is used especially for providing multiple driving signals for the adiabatic pulser. In this context, the number of the multiple driving signals may be equal to the product of the number of levels of the adiabatic pulser and the number of the multiple channels. Accordingly, the beamformer or the beamforming unit, respectively, of FIG. 13 is configured to provide 5*16 driving signals for the adiabatic pulser.

It is noted that it might be particularly advantageous if the device, such as the device 10 of FIG. 12, comprises such a beamformer or a beamforming unit, respectively.

According to FIG. 13, the beamformer or beamforming unit, respectively, may comprise multiple pulse generating units. In this context, the number of the multiple pulse generating units may especially be equal to the number of the multiple channels. Accordingly, in this exemplary case of FIG. 13, the beamformer or beamforming unit, respectively, comprises 16 pulse generating units.

Especially for full charge recycling at all steering angles, the beamformer or the beamforming unit, respectively, may be configured to perform delay skipping. It is noted that the delay skipping has already extensively explained in the context of FIG. 7 to FIG. 11.

Moreover, as it can be seen from FIG. 14, a level shifter, exemplarily having been mentioned in the context of FIG. 12, is used, wherein the supply voltage is equal to 4.8 V and the intermediate supply voltage is equal to 2.4 V, whereas the corresponding functioning of the adiabatic pulser is illustrated by analogy with FIG. 12.

Furthermore, not only with respect to FIG. 13 and FIG. 14 but also regarding FIG. 1 and FIG. 12, it is noted that the corresponding subject-matter of FIG. 1, FIG. 12, FIG. 13, and FIG. 14 may be used in the context of at least one of wireless power transfer, especially wireless power transfer to medical implants, ultrasound imaging, especially ultrasound imaging in a medical context, ultrasound stimulation, especially ultrasound stimulation in a medical context and/or neuromodulation, or any combination thereof.

While various embodiments of the present disclosure have been described above, it should be understood that they have been presented by way of example only, and not limitation. Numerous changes to the disclosed embodiments can be made in accordance with the disclosure herein without departing from the spirit or scope of the disclosure. Thus, the breadth and scope of the present disclosure should not be limited by any of the above-described embodiments. Rather, the scope of the disclosure should be defined in accordance with the following claims and their equivalents.

Although the disclosure has been illustrated and described with respect to one or more implementations, equivalent alterations and modifications will occur to others skilled in the art upon the reading and understanding of this specification and the annexed drawings. In addition, while a particular feature of the disclosure may have been disclosed with respect to only one of several implementations, such feature may be combined with one or more other features of the other implementations as may be desired and advantageous for any given or particular application.

What is claimed is:

1. A method for driving an ultrasound transducer array with beamforming capabilities with the aid of multiple channels, the method comprising the steps of:
generating a respective voltage wave signal with intermediate voltage steps and a certain duration Δ of the intermediate voltage steps for each of the multiple channels by correspondingly connecting the corresponding elements in the ultrasound transducer array to a supply voltage or ground,
defining corresponding relative time delays among the multiple channels to be linear, and
defining phases with respect to the multiple channels such that a certain condition correlates the number of elements in the ultrasound transducer array with the number of generated phases.

2. The method according to claim 1,
wherein, especially in the context of the certain condition, the number of elements in the ultrasound transducer array is equal to an integer multiple k of the number of generated phases.

3. The method according to claim 2,
wherein the method further comprises the step of:
defining a relation regarding a minimum time delay between the multiple channels and the certain duration Δ of the intermediate voltage steps such that the minimum time delay between the multiple channels is equal to two times the certain duration Δ of the intermediate voltage steps.

4. The method according to claim 3,
wherein the method further comprises the step of:
defining a relation regarding a certain time interval t1 within each corresponding period T of the respective ultrasound transducer that each pulse is connected to the supply voltage or the ground, the certain duration Δ of the intermediate voltage steps, and a minimum time delay between the multiple channels, especially the minimum time delay between the multiple channels according to claim 3, such that the sum of the certain time interval t1 and the certain duration Δ of the intermediate voltage steps is equal to an integer multiple k of the minimum time delay between the multiple channels, especially the minimum time delay between the multiple channels according to claim 3.

5. The method according to any of the claim 4,
wherein the method further comprises the step of:
defining a relation regarding the number N of the intermediate voltage steps, the certain duration Δ of the intermediate voltage steps, a certain time interval t1 within each corresponding period T of the respective ultrasound transducer that each pulse is connected to the supply voltage or the ground, especially the certain time interval t1 according to claim 4, and the corresponding period T of the respective ultrasound transducer such that the following equation applies:
$$2 ( N - 2 ) Δ + 2 t 1 = T .$$

6. The method according to claim 5,
wherein the method further comprises the step of:
defining a time delay between the multiple channels to be an odd integer multiple or an even integer multiple of a minimum time delay between the multiple channels, especially the minimum time delay between the multiple channels.

7. The method according to claim 6,
wherein the method further comprises the step of:
in the case that the time delay between the multiple channels is equal to an even integer multiple of the minimum time delay between the multiple channels, modifying the linearity of the corresponding relative time delays among the multiple channels such that at least a part of the corresponding time delay steps between the multiple channels is replaced by respective time delay steps with an odd integer multiple of the minimum time delay between the multiple channels, the odd integer multiple being one less than the even integer multiple.

8. The method according to claim 1,
wherein the method further comprises the step of:
defining a relation regarding a minimum time delay between the multiple channels and the certain duration Δ of the intermediate voltage steps such that the minimum time delay between the multiple channels is equal to two times the certain duration Δ of the intermediate voltage steps.

9. The method according to claim 1,
wherein the method further comprises the step of:
defining a relation regarding a certain time interval t1 within each corresponding period T of the respective ultrasound transducer that each pulse is connected to the supply voltage or the ground, the certain duration Δ of the intermediate voltage steps, and a minimum time delay between the multiple channels, especially the minimum time delay between the multiple channels according to claim 3, such that the sum of the certain time interval t1 and the certain duration Δ of the intermediate voltage steps is equal to an integer multiple k of the minimum time delay between the multiple channels, especially the minimum time delay between the multiple channels according to claim 3.

10. The method according to any of the claim 1,
wherein the method further comprises the step of:
defining a relation regarding the number N of the intermediate voltage steps, the certain duration Δ of the intermediate voltage steps, a certain time interval t1 within each corresponding period T of the respective ultrasound transducer that each pulse is connected to the supply voltage or the ground, especially the certain time interval t1 according to claim 4, and the corresponding period T of the respective ultrasound transducer such that the following equation applies:
$$2 ( N - 2 ) Δ + 2 t 1 = T .$$

11. The method according to claim 1,
wherein the method further comprises the step of:
defining a time delay between the multiple channels to be an odd integer multiple or an even integer multiple of a minimum time delay between the multiple channels, especially the minimum time delay between the multiple channels.

12. A device for driving an ultrasound transducer array with beamforming capabilities with the aid of multiple channels, the device comprising:
multiple switches, each of which especially comprising a capacitance or a parasitic capacitance, for driving the multiple channels, and
a control unit being in communication with the multiple switches,
wherein the control unit is configured to control the multiple switches such that a respective voltage wave signal with intermediate voltage steps and a certain duration Δ of the intermediate voltage steps for each of the multiple channels is generated by correspondingly connecting the corresponding elements in the ultrasound transducer array to a supply voltage or ground,
wherein the control unit is configured to define corresponding relative time delays among the multiple channels to be linear, and
wherein the control unit is configured to define phases with respect to the multiple channels such that a certain condition correlates the number of elements in the ultrasound transducer array with the number of generated phases.

13. The device according to claim 12,
wherein, especially in the context of the certain condition, the number of elements in the ultrasound transducer array is equal to an integer multiple k of the number of generated phases, and/or
wherein the control unit is configured to share the corresponding charge of the multiple switches, especially of the capacitance or the parasitic capacitance of each of the multiple switches, between the multiple switches with the aid of an intermediate supply voltage.

14. The device according to claim 13,
wherein the control unit is further configured to define a relation regarding a minimum time delay between the multiple channels and the certain duration Δ of the intermediate voltage steps such that the minimum time delay between the multiple channels is equal to two times the certain duration Δ of the intermediate voltage steps.

15. The device according to claim 12,
wherein the control unit is further configured to define a relation regarding a minimum time delay between the multiple channels and the certain duration Δ of the intermediate voltage steps such that the minimum time delay between the multiple channels is equal to two times the certain duration Δ of the intermediate voltage steps.

16. The device according to claim 12,
wherein the control unit is further configured to define a relation regarding a certain time interval t1 within each corresponding period T of the respective ultrasound transducer that each pulse is connected to the supply voltage or the ground, the certain duration of the intermediate voltage steps, and a minimum time delay between the multiple channels, especially the minimum time delay between the multiple channels according to claim 10, such that the sum of the certain time interval and the certain duration Δ of the intermediate voltage steps is equal to an integer multiple of the minimum time delay between the multiple channels, especially the minimum time delay between the multiple channels according to claim 10.

17. The device according to claim 12,
wherein the control unit is further configured to define a relation regarding the number N of the intermediate voltage steps, the certain duration Δ of the intermediate voltage steps, a certain time interval t1 within each corresponding period T of the respective ultrasound transducer that each pulse is connected to the supply voltage or the ground, especially the certain time interval t1 according to claim 11, and the corresponding period T of the respective ultrasound transducer such that the following equation applies:
$$2 ( N - 2 ) Δ + 2 t 1 = T .$$

18. The device according to claim 12,
wherein the control unit is further configured to define a time delay between the multiple channels to be an odd integer multiple or an even integer multiple of a minimum time delay between the multiple channels, especially the minimum time delay between the multiple channels.

19. The device according to claim 18,
wherein the control unit is further configured to in the case that the time delay between the multiple channels is equal to an even integer multiple of the minimum time delay between the multiple channels \, modify the linearity of the corresponding relative time delays among the multiple channels \ such that at least a part of the corresponding time delay steps between the multiple channels is replaced by respective time delay steps with an odd integer multiple of the minimum time delay between the multiple channels, the odd integer multiple being one less than the even integer multiple.

20. A system comprising:
a device for driving an ultrasound transducer array with beamforming capabilities with the aid of multiple channels, the device comprising:
multiple switches, each of which especially comprising a capacitance or a parasitic capacitance, for driving the multiple channels, and
a control unit being in communication with the multiple switches,
wherein the control unit is configured to control the multiple switches such that a respective voltage wave signal with intermediate voltage steps and a certain duration Δ of the intermediate voltage steps for each of the multiple channels is generated by correspondingly connecting the corresponding elements in the ultrasound transducer array to a supply voltage or ground,
wherein the control unit is configured to define corresponding relative time delays among the multiple channels to be linear, and
wherein the control unit is configured to define phases with respect to the multiple channels such that a certain condition correlates the number of elements in the ultrasound transducer array with the number of generated phases, and
an ultrasound transducer array being driven by the multiple channels,
wherein the system is used in the context of at least one of wireless power transfer, especially wireless power transfer to medical implants, ultrasound imaging, especially ultrasound imaging in a medical context, ultrasound stimulation, especially ultrasound stimulation in a medical context and/or neuromodulation, or any combination thereof.
